(19) United States
(12) Patent Application Publication
(10) Pub. No.: US 2009/0091547 A1
(43) Pub. Date: Apr. 9, 2009

(54) INFORMATION DISPLAY DEVICE

(75) Inventor: Yumiko Kikuoka, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/212,031

(22) Filed: Sep. 17, 2008

(30) Foreign Application Priority Data
Oct. 3, 2007 (JP) 2007-259697

(51) Int. Cl. G06F 3/041

(52) U.S. Cl. 345/173

(57) ABSTRACT

An information display device having a large display screen that facilitates input/edit to a position away from the operation position of a user is provided. This information display device is equipped with a touch sensor on a display screen to enable an operation for screen display through a touch operation on the screen, equally divides the screen horizontally and vertically, sets a sub-screen area that displays a divided image of an image displayed on the screen, and transforms a touch operation position in the sub-screen area into a position on the display screen to replace a touch operation in the sub-screen area with an operation of the screen display on the display screen for enabling a remote operation.

### CROSS-NOTING PARAGRAPH

This Non-provisional application claims priority under U.S.C. §119(a) on Patent Application No. 2007-259697 filed in JAPAN on Oct. 3, 2007, the entire contents of which are hereby incorporated herein by reference.

### FIELD OF THE INVENTION

The present invention relates generally to an information display device, and, more particularly, to a technique for displaying information with the use of a large display screen allowing touch input.

### BACKGROUND OF THE INVENTION

Conventionally, a whiteboard includes a printing means that optically scans contents of proceedings (image information) written on the whiteboard with a writing material such as a felt pen and prints the obtained image information on a thermal paper, and the printing means is used for printing the contents of proceedings (image information) written on the whiteboard on the thermal paper after the conference is over, which is copied and distributed to conference participants.

In a conference using a conventional whiteboard, it may be necessary to newly computerize printed contents of proceedings with the use of a word processor, etc., after the conference.

In an electronic conference system proposed in Japanese Laid-Open Patent Publication No. 2000-56747, a direct input means (e.g., a touch pen) is used to directly write contents of proceedings on a large display in a free format, and these contents of proceedings are entirely computerized to easily perform document management, distribution to participants, processing of contents, etc., after a conference.

In an image displaying system presented in Japanese Laid-Open Patent Publication No. 2002-196739, when pen input is performed on an image displayed on a large screen or a small screen of a main display, the same contents are input into an image displayed on the large screen or the small screen of the main display or a sub-display.

The electronic conference systems as described above are assumed to be used in a conference room having a certain level of space and have a height within arm's reach and a length not causing a troublesome moving distance for users.

However, display devices such as liquid crystal displays increasingly grow in size, and if a such large display device is disposed in a large space such as a lecture room of a college or an international conference hall, it becomes more common that the upper part is out of reach or an effort is needed to go to the edges of the display for writing or manipulation.

Japanese Laid-Open Patent Publications No. 2000-056747 and No. 2002-196739 do not provide a means for input into the upper part and the edges out of reach or a means for input into a difficult area.

### SUMMARY OF THE INVENTION

The object of the present invention is to provide an information display device having a large display screen that facilitates input/edit to a position away from the operation position of a user.

The information display device of the present invention is equipped with a touch sensor on a display screen to enable an operation for screen display through a touch operation on the screen, sets a sub-screen area that displays a divided image of an image displayed on the screen, and shifts a touch operation position in the sub-screen area to a position on the display screen to replace a touch operation in the sub-screen area with an operation of the screen display on the display screen for enabling a remote operation.

The sub-screen displays an image of an area on the display screen corresponding to a divided area selected by a user from areas made by equally dividing the display screen horizontally and vertically each.

The position of the sub-screen area is preliminarily settable and is set at either the right or left corner that is closer to the touch position of the display screen or in the vicinity of an input portion for operating the information display device.

The operationality of input/edit improves since an arbitrary divided area can be selected.

Since the divided area on the display screen corresponding to the sub-screen is displayed differently from other divided areas, a user easily understands which divided area is defined as a target of input/edit.

If a drag operation is performed on the sub-screen and passes over any side of the sub-screen area, position transformation is performed on the display screen not to pass over a side of the divided area corresponding to the side of the sub-screen area so that the same operations are performed on the sub-screen and the display screen.

Besides, the sub-screen area is movable, which improves the operationality since input/edit can be performed regardless of the position of the user.

### BRIEF DESCRIPTION OF THE DRAWINGS

FIG. 1 is an explanatory view of a display screen and coordinate axes;

FIGS. 2A to 2E are explanatory views of an outline of operation on a large display screen;

FIG. 3 is a block diagram of a hardware configuration of an information display device;

FIG. 4 is a block diagram of a functional configuration of the information display device according to a first embodiment;

FIG. 5 is an example of data structure on a screen control table according to the first embodiment;

FIG. 6 is an explanatory view of a setting order of divided area IDs;

FIG. 7 is an example of a menu for input mode selection;

FIG. 8 is an explanatory flowchart about a processing for transforming a contact position into a coordinate system on a display screen;

FIG. 9 is a block diagram of a functional configuration of an information display device according to a second embodiment; and

FIG. 10 is an example of a menu for input mode selection.

### PREFERRED EMBODIMENTS OF THE INVENTION

Embodiments according to the present invention will hereinafter be described with reference to the drawings.

### First Embodiment

In a first embodiment, an information display device equipped with a large display screen having an interactive whiteboard function will be described as an example. This information display device is a two-dimensional surface device that displays a computer desktop, has the interactive whiteboard function including

(1) an editable mode to input the edit operations for characters and graphics written on the surface by a user and the displayed objects (e.g., displayed windows, characters, graphics, and images) into a computer,

(2) an uneditable mode to directly display original displayed data and input the writings thereon into a computer, and

(3) a board off mode which is set when the whiteboard is used as a display device of a computer, and is more usable as a versatile interactive computer screen although it can be used as an electronic blackboard.

Situations of using this interactive whiteboard function may include schools, business presentations, cooperative works, etc.

Although a display screen of the first embodiment will be described as a vertically elongated display screen, the screen may be vertically elongated or horizontally elongated.

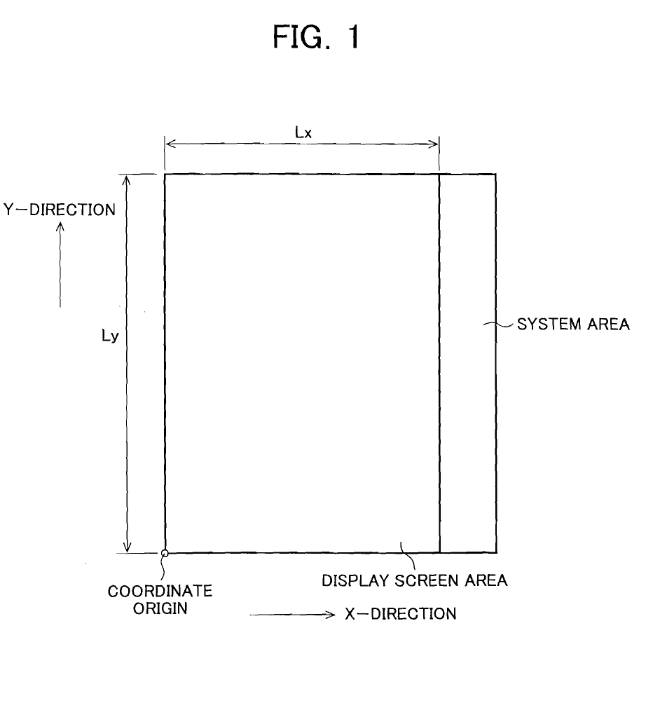

As shown in FIG. 1, a whole area of the display screen is made up of a display screen area and a system area, and the display screen area is represented by an XY coordinate system, where the point of the lower left corner of the display screen area is defined as the coordinate origin, the right horizontal direction is defined as the positive direction along the X axis, and the vertical upward direction is defined as the positive direction along the Y axis.

It is assumed that the display screen area has a horizontal size of Lx and a vertical size of Ly. A unit of size may be a pixel unit or a metric unit.

The system area is an area used for a input mode selection used by a control program and application programs, etc., an operation menu for an edit mode or input of parameter thereof, and operation instruction such as power-on/off, and is displayed at the lower right corner of the display screen. The system area, however, may not be set in advance on the display screen and the above controls may be performed by operating a button disposed outside the screen of the information display device. Further, the system area itself may be displayed in the display screen area as needed.

An outline of operation on the display screen of the first embodiment will be described.

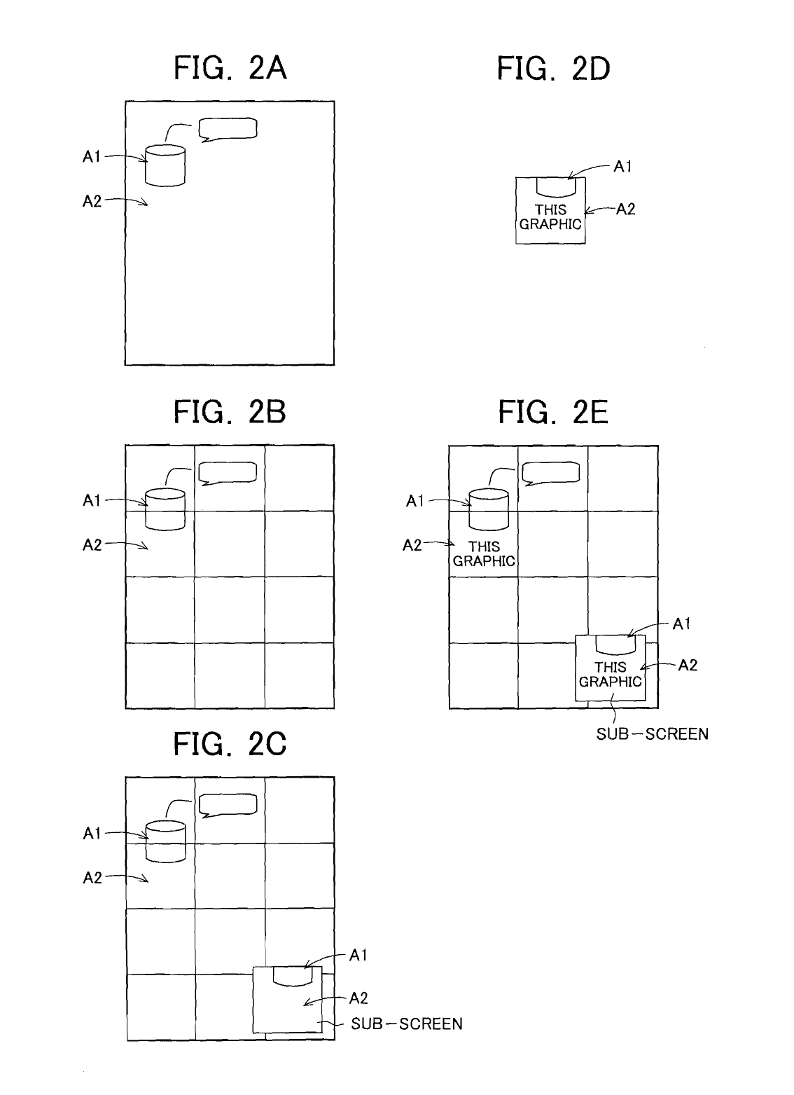

For example, as shown in FIG. 2A, when a graphic Al is displayed on the upper side of the display screen area and a user wants to add an explanation of the graphic A1 or another graphic to a position A2 near the graphic, it is assumed that an pointing means (such as an electronic pen, a finger, or a bar, etc.) held by the user cannot reach the position A2.

The user gives an instruction to divide the display screen as shown in FIG. 2B. In this example, the display screen is divided into 3 along horizontal direction and into 4 along vertical direction.

When the user points a divided area including the position A2 among divided areas, a sub-screen corresponding to this divided area is displayed at a position set on the display screen as shown in FIG. 2C.

The sub-screen is a screen made by taking out a part of the display screen and all the inputs/edits performed on the sub-screen are reflected on the display screen. Furthermore, if the display screen is set to the editable mode or the uneditable mode, inputs/edits are performed on the sub-screen in the same mode.

Therefore, inputs/edits at the position A2 on the sub-screen are equivalent to inputs/edits at the position A2 on the display screen.

For example, if “this graphic” is written at the position A2 on the sub-screen, “this graphic” is written at the position A2 of the display screen (FIG. 2E).

Thus, the inputs/edits to an area of the display screen where the user cannot reach can remotely be performed by treating the area as a sub-screen.

A hardware configuration of the information display device will then be described.

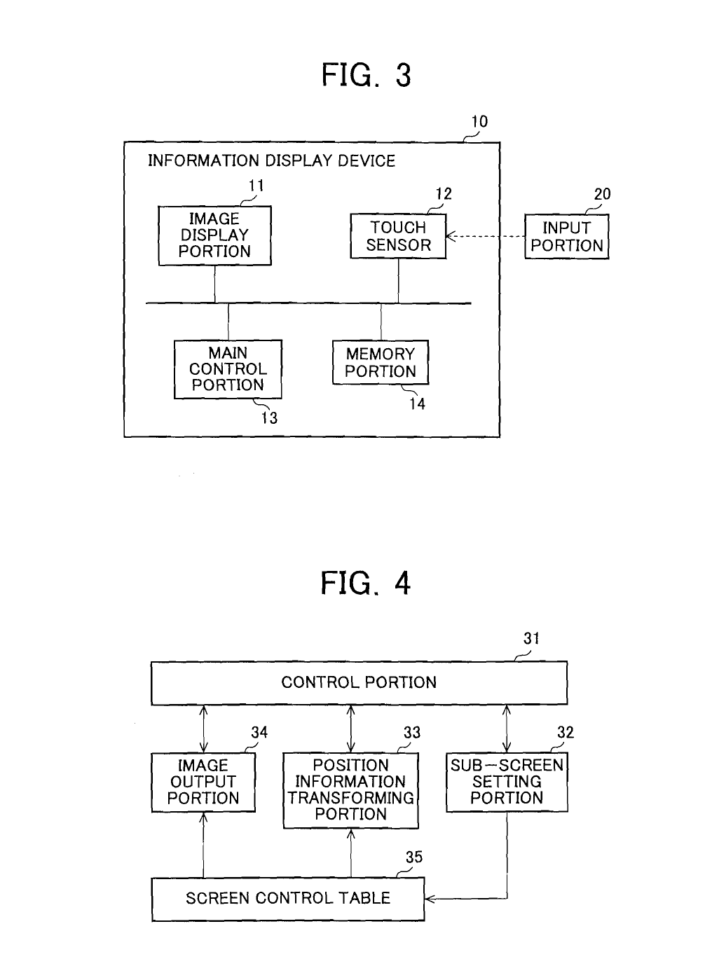

FIG. 3 is a block diagram of a hardware configuration of the information display device and in FIG. 3, an information display device 10 consists of an image display portion 11, a touch sensor 12, a main control portion 13, and a memory portion 14. Although the information display device 10 is described as an integrated apparatus configured with a displaying device consisting of the image display portion 11 and the touch sensor 12 and an information processing device consisting of the main control portion 13 and the memory portion 14, these devices may be provided as separate devices independent each other.

The memory portion 14 is made up of, for example, a RAM (Random Access Memory), a ROM (Read Only Memory), or an HDD (Hard Disc Drive), etc., stores therein a control program executed by the main control portion 13, various application programs, and data used in these programs, and is also used as a buffer which stores therein data temporarily generated during execution of these programs. For example, application programs include an electronic blackboard system.

The image display portion 11 is made up of an liquid crystal display, etc., including a large display screen and displays the image data resulting from the execution of the control program and various application programs on the large display screen.

An input portion 20 is a pointing means (pointing device) capable of pointing a position (coordinates) on the display screen. The pointing means may be a human finger, a pencil, an electronic pen, and a bar, for example.

The touch sensor 12 is disposed on the display screen of the image display portion 11 and transmits position information consisting of a contact position and a contact status of the input portion 20 by means of an infrared sensor, a pressure-sensitive sensor, or a capacitance-sensitive sensor to the main control potion 13, for example.

The contact status represents a “contact state” or a “noncontact state”. The “contact state” is a state that the input portion 20 is maintained in contact with the display screen and the “noncontact state” represents a click when contact is made once, a double-click when contact is made twice, or a state that the input portion 20 is released from the contact state.

The contact position is coordinates at the time when the input portion 20 comes into contact with the display screen or coordinates at the time when the input portion 20 is released from contact, and is represented by the coordinate system of the display screen.

When the input portion 20 is maintained in contact with the display screen, the touch sensor 12 monitors the contact status at predetermined intervals and sequentially transmits the position information consisting of the contact position and the contact status to the main control portion 13.

The main control portion 13 is made up of, for example, a CPU (Central Processing Unit), etc., and executes the control program and various application programs stored in the memory portion 14 to control the whole of the information display device 10.

This control program is a program for controlling the information display device 10 and includes an image output portion that outputs a drawing instruction indicated by the control program or various application programs or a drawing result onto the display screen and the sub-screen.

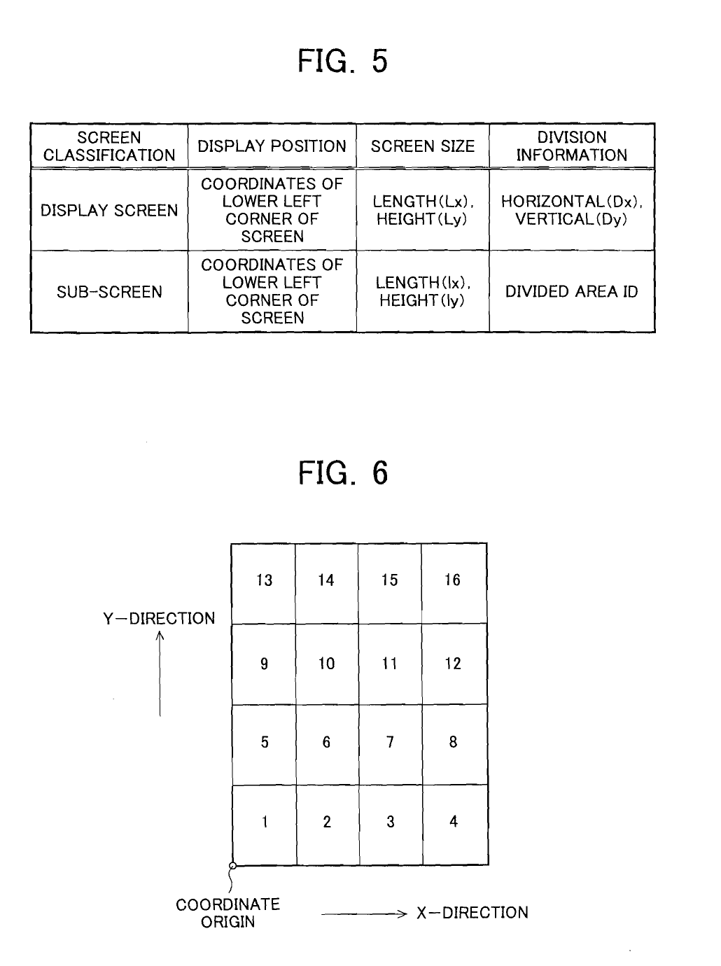

A functional configuration of the information display device according to the first embodiment will then be described with reference to a block diagram of FIG. 4. In FIG. 4, the functions of the information display device include a control portion 31, a sub-screen setting portion 32, a position information transforming portion 33, and an image output portion 34. A screen control table 35 is necessary for operating these portions.

The control portion 31 is configured as a part of the control program and performs control of the sub-screen setting portion 32, the position information transforming portion 33, and the image output portion 34 as well as control of executions of application programs.

The screen control table 35 for controlling the display screen and the sub-screen will first be described. The screen control table 35 is recorded in the memory portion 14 and includes data items exemplarily illustrated in FIG. 5.

Screen classification: storing classification data indicating either the display screen or the sub-screen.

Display position: storing the coordinates that represent the position of the lower left corner of a screen classified by the screen classification. Although the coordinates are fixed to the coordinate origin of the display device in the case of the display screen, the coordinates are predetermined values or are variable depending on setting by a user in the case of the sub-screen.

Screen size: storing the size of the screen classified by the screen classification using a length and a height. The size has a length Lx and a height Ly in the case of the display screen, and is the same size as one of divided screen area made when the display screen is divided in the case of the sub-screen, which has a length lx and a height ly.

Division information: storing a horizontal division number (Dx) and a vertical division number (Dy) when the screen classification is the display screen and if no sub-screen exists, the information is cleared. When the screen classification is the sub-screen, an ID is stored to identify a divided area that is a target of input/edit specified by a user.

As shown in FIG. 6, the divided area ID is started from value of one and sequentially assigned from an area with the smallest X-coordinate value toward an area with the largest X-coordinate value fixing the Y-coordinate value to the origin, and if the ID is assigned to all the divided areas in the X-direction, the ID is assigned in the same way to the divided areas having the Y-coordinate values greater than the Y-coordinate values of the divided areas having the ID already assigned. This procedure is repeated until the ID is assigned to all the divided areas.

The image output portion 34 executes a drawing instruction given from the control program or application programs to generate image data for the display screen and output it to a main buffer memory reserved in the memory portion 14.

The image output portion 34 then takes out image data of the divided area on the display screen corresponding to the divided area ID from the image data stored in the main buffer memory to generate image data for the sub-screen in a sub-buffer memory reserved in the memory portion 14.

Although the divided area on the display screen corresponding to the sub-screen is displayed with, for example, color or shading to be differentiated from other divided areas, the sub-screen may be differentiated from or the same as other divided areas.

The image output portion 34 overwrites and combines the image data of the sub-screen generated in the sub-buffer memory to the display position where the sub-screen is displayed in the image data of the display screen stored in the main buffer memory, which are written on an image memory reserved on the memory portion 14.

As above, when the image memory is rewritten, the image output portion 34 sends the contents of the rewritten image memory to the image display portion 11 to display images on the display screen and the sub-screen on the large display screen.

A method of using the sub-screen will then be described.

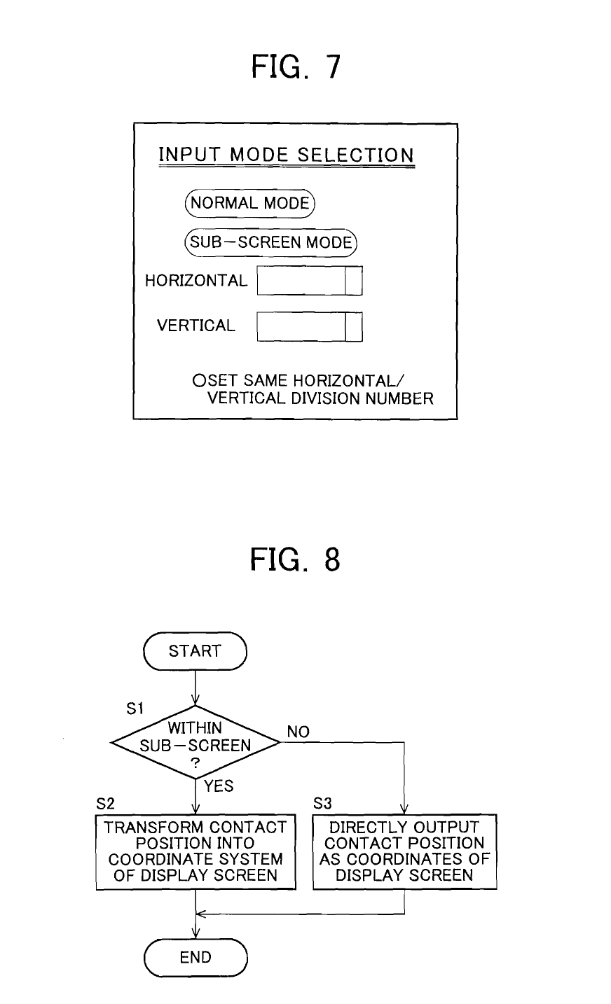

A user selects a normal mode for performing input/edit directly on the display screen or a sub-screen mode for performing input/edit on the sub-screen depending on whether the input portion 20 can directly operate a target of input/edit. As shown in FIG. 7, the screen control table 35 is set to either mode by clicking either button of the “normal mode” or the “sub-screen mode” in the input mode selection set in the system area with the input portion 20.

When a user clicks the “normal mode”, the control portion 31 determines that the “normal mode” button of the input mode selection has been clicked based on the position information (contact status and contact position) received from the touch sensor 12 and activates the sub-screen setting portion 32 to send “normal mode” setting information thereto.

When receiving the “normal mode” setting information from the control portion 31, the sub-screen setting portion 32 clears the division information for the display screen in the screen control table 35, moreover clears the display position, the screen size, and the division information for the sub-screen, and gives an instruction for deleting the display on the sub-screen to the image output portion 34 to terminate the execution.

If a user wants to activate the sub-screen mode, the user selects the horizontal division number and the vertical division number and then clicks the “sub-screen mode” button with the input portion 20 (FIG. 7).

When selecting the horizontal division number and the vertical division number, respective available division numbers are preliminarily prepared and the user clicks a button to display choices for the division numbers. A desired division number is selected by clicking the number from the choices. If the user desires the same number for the horizontal and vertical division numbers, the user clicks the radio button “set same horizontal/vertical division number” together with selecting either horizontal or vertical division number mentioned above.

If the control portion 31 determines that the “sub-screen mode” button of the input mode selection has been clicked, the sub-screen setting potion 32 is activated to send thereto the setting information which includes the “sub-screen mode”, the horizontal division number (Dx), the vertical division number (Dy), and a flag indicating whether the same division number is used.

When receiving the “sub-screen mode” setting information from the control portion 31, the sub-screen setting portion 32 checks the division number (Dx), the vertical division number (Dy), and the flag indicating whether the same division number is used to determine the division number (Dx) and the vertical division number (Dy), which are set as the division information for the display screen on the screen control table 35.

Then, the sub-screen setting portion 32 calculates a size of the sub-screen based on a size of the display screen and the division information as follows, for example, and which is set to the size of the sub-screen on the screen control table 35.

sub-screen length (lx)=display screen length (Lx)/display screen horizontal division number (Dx)

sub-screen height (ly)=display screen height (Ly)/display screen vertical division number (Dy)

The display position of the sub-screen is calculated to be a position adjacent to the lower edges of the system area and the display screen and allowing the sub-screen with the size mentioned above to be displayed, and which is set to the display position for the sub-screen on the screen control table 35.

Although the display position for the sub-screen is assumed here to be a preset default value (at the lower right corner of the display screen in the vicinity of the system area), this is not to be considered limited. The default value may be set by the user or the position may be the lower center part or the lower left corner of the display screen, or may be a position touched by the user, or may be an either position of the lower right corner, the lower center part, and the lower left corner closer to the touched position.

The sub-screen setting portion 32 obtains the divided area ID for input/edit performed on the sub screen as follows.

The sub-screen setting portion 32 generates a display screen with division lines added in accordance with the horizontal/vertical division numbers which were set, demagnifies the whole image on the display screen to the size of the sub-screen with the use of the image output portion 34, and combines the display screen and the sub-screen and displays it on the image display portion 11.

As a result, the image with the division lines which have been added to the image displayed on the display screen is displayed on the display screen and the sub-screen.

A user then selects a divided area where the user wants to perform input/edit from the display screen, and clicks the position for the sub-screen corresponding to the divided area with the input portion 20.

The sub-screen setting portion 32 receives the information of the position clicked with the input portion 20 from the touch sensor 12, determines the divided area where the user wants to perform input/edit based on the display position of the sub-screen, the size of the sub-screen, and the horizontal/vertical division number, and sets the division area ID corresponding to the division area as the division information for the sub-screen on the screen control table 35.

The sub-screen setting portion 32 then generates image data of the display screen with the selected divided area that is displayed differently from other divided areas. “Displaying differently” here includes changing color, adding shading, etc.

The sub-screen setting portion 32 displays an image of the display screen corresponding to the selected divided area on the sub-screen using the image output portion 34 and then terminates the execution.

Subsequently, contents of input/edit performed on the sub-screen are considered to be performed on the display screen.

Although a selection is made from the system area when setting the sub-screen in the example described above, this is not to be considered limited, and when clicking the “sub-screen mode” button, the horizontal/vertical division number may directly be input and it may be determined whether the input division number is within the available division numbers of the information display device to determine the division number.

If the position information received from the touch sensor 12 which is on the display screen other than the system area or the sub-screen, the control portion 31 activates the position information transforming portion 33 to send the position information thereto.

The position information transforming portion 33 receives the position information sent from the touch sensor 12, transforms the coordinates of the contact position into the coordinate system of the display screen with a method described later, and sends the transformed coordinates and the contact status to the control portion 31.

The control portion 31 sends to the running program the contact status of the input portion 20 and the transformed coordinates of the contact position on the display screen sent from the position information transforming portion 33.

Therefore, since the program is always supplied with the coordinates on the displays screen in both cases that the display screen is touched or the sub-screen is touched with the input portion 20, the same result can be obtained when a user performs input/edit on either screen.

A process of transforming the contact position obtained by the touch sensor 12 into the coordinate system of the display screen will then be described with a flowchart of FIG. 8.

In the following description, (x₀, y₀) is the origin of the sub-screen that is the display position of the sub-screen; (x, y) is the coordinates of the contact position; (x₁, y₁) is the origin of the divided area corresponding to the sub-screen; and (X, Y) is the coordinates of the contact position transformed for the display screen.

It is checked whether the contact position (x, y) is located within an area of the sub-screen represented by the “display position” and the “display size” of the sub-screen on the screen control table 35 (step S1).

If the contact position (x, y) is located within the sub-screen area (step S1/YES), the contact position (x, y) is transformed to the coordinates (X, Y) on the display screen with the following equations, and after outputting the transformed coordinates (X, Y), the processing is terminated (step S2).

X=x₁+(x−x_{c})

Y=y₁+(y−y_{c})

On the other hand, if the contact position (x, y) is not located within the sub-screen area (step S1/NO), the contact position (x, y) is directly output as the coordinates (X, Y) on the display screen and the processing is terminated (step S3).

However, when the contact position of the input portion 20 is located within the sub-screen area, if the input portion 20 is moved to the outside of the sub-screen area keeping contact with the screen, the position coordinates go outside the specified divided area in the case of using the above equations, and the operations on the sub-screen are mismatched with the operations on the display screen.

Therefore, in the transformation at step S2, the following transformation is performed with respect to the coordinates x and y going outside the sub-screen area to prevent the transformation from causing the transformed position to go outside the specified divided area.

in the case of x<x₀, X=x₁, (1)

in the case of x>(x₀+lx) X=x₁+lx, (2)

in the case of y<y₀, Y=y₁, (3)

in the case of y>(y₀+ly) Y=y₁+ly, (4)

With the configuration described above, input/edit to the position away from the operation position of the user is facilitated.

### Second Embodiment

In the description of the first embodiment, after a user specifies the divided area which is displayed on the sub-screen, input/edit is performed for the same divided screen area. However, when a user wants to perform input/edit for another divided area, it is bothersome to repeat from the input and instruction for the sub-screen mode in each case.

In some cases, it may be desirable to move the display position of the sub-screen.

In a second embodiment, when the display screen is already divided, a user can arbitrarily changes the divided area to another area to perform input/edit and may move the display position of the sub-screen.

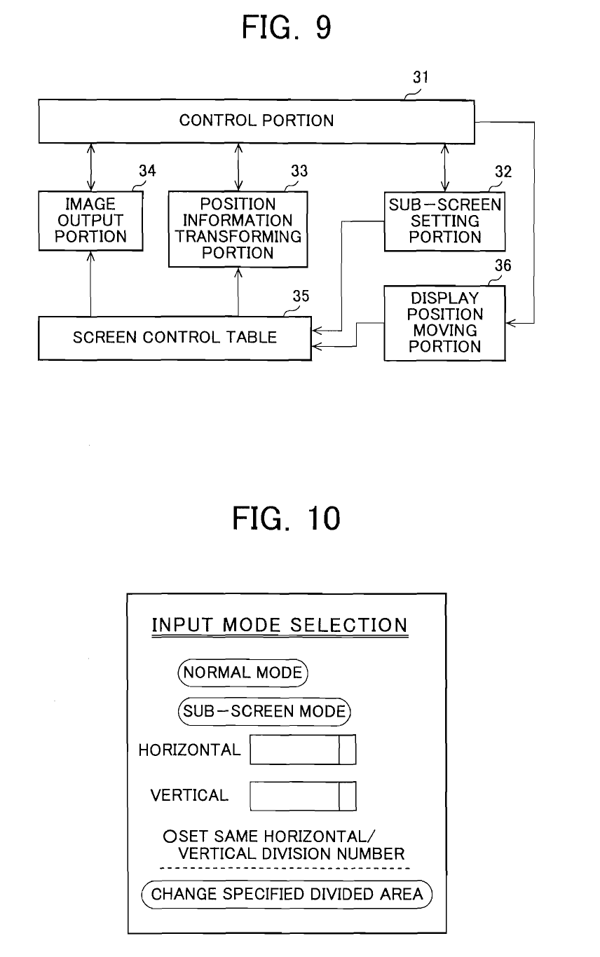

FIG. 9 is a block diagram of a functional configuration of an information display device according to the second embodiment. In FIG. 9, the functions of the information display device include the control portion 31, the sub-screen setting portion 32, the position information transforming portion 33, the image output portion 34, and a display position moving portion 36. The screen control table 35 is necessary for operating these portions. The display position moving portion 36 is not an essential constituent element and is arbitrarily selected as needed.

The same functional constituent elements as described in the first embodiment are given the same reference numerals and will only be described for changes and additions.

When a user changes the specification of the divided area that is the target of input/edit in the sub-screen mode, a user clicks a “change specified divided area” button with the input portion 20 in the input mode selection provided in the system area (FIG. 10).

When the control portion 31 determines that the “change specified divided area” button of the input mode selection has been clicked based on the position information (contact status and contact position) received from the touch sensor 12 in the sub-screen mode, the control portion 31 activates the sub-screen setting portion 32 to send “change specified divided area” setting information thereto.

When the sub-screen setting portion 32 is activated by the control portion 31 and receives the “change specified divided area” setting information, the sub-screen setting portion 32 demagnifies the whole image on the display screen with division lines added in accordance with the horizontal/vertical division numbers to the size of the sub-screen with the use of the image output portion 34, then combines the display screen and the sub-screen and displays it on the image display portion 11.

The user then selects a divided area where the user wants to perform input/edit from the display screen, and clicks with the input portion 20 a position of the sub-screen corresponding to this divided area.

The sub-screen setting portion 32 receives the information of the position clicked with the input portion 20 from the touch sensor 12, determines the divided area where the user wants to perform input/edit based on the display position of the sub-screen, the size of the sub-screen, and the horizontal/vertical division number, and sets the division area ID corresponding to this division area as the division information for the sub screen of the screen control table 35.

The sub-screen setting portion 32 generates image data on the display screen with the changed and selected divided area that is displayed differently from other divided areas and displays the image data of the changed and selected divided area on the sub-screen using the image output portion 34 and then terminates the execution.

Subsequently, contents of input/edit performed on the sub-screen are considered to be performed on the display screen in the changed and selected divided area.

The display position moving portion 36 sets a change about the display position of the sub-screen on the screen control table 35 as follows.

A user grabs and drags one of the sides of the sub-screen with the input portion 20 to a desired position, and releases the grabbed side.

If it is determined that one of the four sides of the sub-screen is grabbed based on the position information (contact status and contact position) at the time of start of the dragging, the control portion 31 activates the display position moving portion 36.

The display position moving portion 36 is activated and keeps obtaining the position information transmitted from the touch sensor 12 until it is detected that the grabbed side of the sub-screen is released. During this time, the display position moving portion 36 displays the movement of the contour of the dragged sub-screen.

If it is detected that the grabbed side of the sub-screen is released, the display position moving portion 36 sets the coordinates of the lower left corner of the currently displayed sub-screen as the “display position” for the sub-screen on the screen control table 35, redisplays the contents of the specified divided area on the sub-screen, and terminates the execution.

With the configuration described above, input/edit to the position away from the operation position of the user is facilitated. When the same division numbers as the horizontal/vertical division numbers which have been already selected and applied are continuously used, the division number may not be input in each case and the operationality is improved since only the divided area defined as the target of input/edit may be selected.

The above embodiments are not intended to limit the present invention. It is apparent that various modifications of the embodiments are allowed within the scope of the present invention without deviating from the substance of the present invention.

According to the present invention, the following effects may be obtained.

The present invention enables the information display device having a large display screen to facilitate input/edit to a position away from the operation position of a user.

1. An information display device equipped with a touch sensor on a display screen to enable an operation for screen display through a touch operation on the screen, the information display device equally dividing the screen horizontally and vertically, the information display device setting a sub-screen area that displays a divided image of an image displayed on the screen, the information display device shifting a touch operation position in the sub-screen area to a position on the display screen to replace a touch operation in the sub-screen area with an operation of the screen display on the display screen for enabling a remote operation.

2. The information display device as defined in claim 1, wherein the position of the sub-screen area is preliminarily settable.

3. The information display device as defined in claim 2, wherein the sub-screen area is set at either the right or left corner that is closer to the touch position of the display screen.

4. The information display device as defined in claim 2, wherein the sub-screen area is set in the vicinity of an input portion operating the information display device.

5. The information display device as defined in claim 1, wherein the display of the divided area on the display screen corresponding to the sub-screen display is displayed differently from other divided areas.

6. The information display device as defined in claim 1, wherein if a drag operation in the sub-screen area passes over any side of the sub-screen area, transformation is performed on the display screen to a position not passing over a side of the divided area corresponding to the side.

7. The information display device as defined in claim 1, wherein the divided area corresponding to the sub-screen is arbitrarily selectable.

8. The information display device as defined in claim 1, wherein the sub-screen is movable.
